(19) United States
(12) Patent Application Publication
(10) Pub. No.: US 2008/0182918 A1
(43) Pub. Date: Jul. 31, 2008

(54) Monolithic Functionalisable Materials

(75) Inventors: Katarzyna Chuda, Paris (FR); Xavier Coqueret, Phalempin (FR)

Correspondence Address: McLELAND PATENT LAW OFFICE, P.L.L.C., 11320 RANDOM HILLS ROAD, SUITE 250, FAIRFAX, VA, 22030, US

(73) Assignee: UNIVERSITE DES SCIENCES ET TECHNOLOGIES DE LILLE, Villeneuve d'Ascq (FR)

(21) Appl. No.: 11/910,964

(22) PCT Filed: Mar. 31, 2006
(86) PCT No.: PCT/FR2006/000716

§ 371 Date: Oct. 8, 2007

(30) Foreign Application Priority Data
Apr. 8, 2005 (FR) 0503529

(51) Int. Cl. C08F 222/06; C08F 2/46

(52) U.S. Cl. 522/168; 526/271; 526/272

(57) ABSTRACT

The invention relates to a monolithic polymer material comprising alternating copolymers formed by a radical reaction between a maleic anhydride in the form of a base monomer and ethylene comonomers in the form of electron donors. The invention also relates to a method for preparing said monolithic material consisting in carrying out a radical polymerization reaction of a composition which comprises a base composition containing a maleic anhydride in the form of a base monomer associated with the ethylene comonomers in the form of electron donors and/or with other ethylene comonomers in the form of electron donors or receivers and a mixture of pore-forming solvents, wherein said base composition is optionally supplemented with a thermal initiator or photo initiator.

The present invention relates to the area of porous monolithic organic materials. The invention also concerns the different methods to prepare these materials.

These monolithic materials have certain advantages compared with more conventional macroporous materials, related in particular to the absence of interstitial spaces in compacted form.

One general method to prepare porous, monolithic, organic materials in desired elements inside a simple cavity (column, capillary) or microsystem (channels, reservoirs, chambers, branch points) is based on in situ polymerization via thermal, photochemical or radiochemical route of monomers dissolved in a mixture of porogenic solvents.

Various monolithic materials for analytical Microsystems and their methods of preparation have been described in the literature. Amongst these methods, those which use the thermal route are characterized by relatively long polymerization times (16 to 26 h) and high polymerization temperatures (60 to 90° C.). Also, the porous phases obtained are most often optimized for a single type of application. More especially, known monolithic materials do not have functionalization capability, or their content of functionalizable groups is too low. Additionally, the reactivity of the functionalizable groups currently used (epoxy, azlactone) is weak and requires long treatments and/or treatment under severe conditions.

The object of the present invention is firstly to propose novel functionalizable monolithic materials that are customized after adjustment of porosity-permeability characteristics, and secondly to propose methods to prepare these monolithic materials, characterized by their simplified implementation.

According to one first aspect, the subject-matter of the invention concerns polymer monolithic materials containing maleic anhydride functions able to be functionalized.

According to a second aspect, the invention relates to a method for preparing functionalizable monolithic materials, said method comprising a prior surface treatment step of the walls which act as support for said monolithic materials, characterized in that it consists of a thermal, photochemical or radiochemical radical polymerization reaction of a composition comprising a base composition, containing:
maleic anyhydride as base monomer, known for its electron-accepting nature promoting the formation of charge transfer complexes with electron-donor monomers, associated with electron-donor ethylene comonomers and/or with other electron-donor or electron-acceptor ethylene monomers,
a mixture of porogenic solvents,
   a photoinitiator or thermal initiator optionally being added to said base composition.

According to a third aspect, the invention relates to compositions containing maleic anhydride, comonomers and/or other monomers and porogenic solvents used to prepare monolithic materials according to the invention.

According to a fourth aspect, the invention concerns monolithic materials in which the maleic anhydride functions are functionalized by reaction with nucleophilic compounds. The properties resulting from this functionalization are extremely varied: adjustable hydrophilic/hydrophobic balance, presence of positive or negative electric charges, of varied functional organic groups, possibly optically active, of specific substrates, of artificial or enzymatic catalytic sites, etc.

This diversity of accessible properties allows the functional properties of porous materials to be adjusted to act as phase in chromatography by hydrophobic, affinity, ionic interaction, electrochromatography, capillary electrophoresis, as reactor, as support for the absorption and analysis of chemical compounds, as sensor in a detection device. According to a fifth aspect, the invention therefore relates to the various uses of the functionalized monolithic materials in analytical microsystems.

The invention will now be described in detail.

According to a first aspect, the subject-matter of the invention is a polymer monolithic material with functionalizable groups, characterized in that these groups are maleic anhydride units.

The choice made by the applicant focused on monoliths with high maleic anhydride content, since it has two particular characteristics:
a tendency to form alternating copolymers by radical reaction with electron-donor ethylene monomers (vinyl ethers, N-vinyl derivatives),
the ability to initiate its photochemical copolymerization with electron-donor ethylene monomers (vinyl ethers, N-vinyl derivatives) without having recourse to a specific radical photoinitiator.

The different applications most often require the preparation of porous monolithic phases with optimal functional and fluidic characteristics. Experience has shown that the microstructure and porosity of monoliths depend heavily on the composition of the precursor reaction mixture (type and quantity of monomers, type and composition of the porogenic mixture) and on preparation conditions (temperature, type and kinetics of the initiating reactions, thermal, photochemical or radiochemical treatment time).

These two characteristics are interdependent, each change in a chemical property, through a change in the composition of the precursor reaction mixture, requiring an adjustment of the treatment conditions with a view to obtaining optimal functional and fluidic properties.

To overcome this difficulty inherent in the conventional preparation method, the applicant has developed an approach based on the preparation of monoliths with a high number of reactive sites which can be chemically modified after their preparation, by reaction with compounds providing some of the desired functional properties.

For this purpose and according to a second aspect, the invention concerns a method for preparing functionalizable monolithic materials, said method comprising a prior surface treatment step of the walls which act as support for said monolithic materials, characterized in that it consists of a thermal, photochemical or radiochemical, radical polymerization reaction of a composition comprising a base composition containing:
maleic anhydride as base monomer, associated with electron-donor ethylene comonomers and/or with other electron-donor or electron-acceptor ethylene monomers,
a mixture of porogenic solvents,
   said base composition optionally also containing a photoinitiator or thermal initiator.

The monolithic materials were prepared in hollow bodies or objects of varied size and shape, comprising a cavity delimited by surfaces consisting of various materials, hereinafter designated as “containing objects”. Examples of said containing objects are:
tubes and capillaries in glass or fused silica (diameter 50 μm to 10 mm) lending themselves to the preparation of monoliths by thermal, photochemical or radiochemical polymerization;
systems and devices of various geometries, consisting of glass, silica, silicon, metals, polymer materials (thermoplastics, networks, resins for lithography), or the combination of these various types of materials, comprising channels or chambers with a diameter of between 100 nm and 5 cm.

These containing objects are more specifically adapted for preparing monolithic materials by photopolymerization when the cavity is delimited on one of its surfaces by a material transparent to visible-UV radiation. In other cases, the preparation of the monolithic materials is possible using thermal or radiochemical polymerization.

In one variant of embodiment, the method to prepare monolithic materials comprises a thermal polymerization reaction of a composition A containing a thermal initiator, in addition to the base composition, said reaction being conducted at a temperature of 40° to 90° C. for a time of between 1 and 6 h.

In another variant of embodiment, the method for the preparation of monolithic materials comprises a photochemical polymerization reaction of a composition B containing a photoinitiator in addition to the base composition.

The choice of the type and quantity of initiator added to the formulation, of the spectral domain used, and of the light source power is of major importance to obtain the desired morphological and fluidic characteristics. The formulation of the monomers and solvents with a photoinitiator is degassed for 5 min in nitrogen. The containing objects are then filled with the solution and placed under a variable ultraviolet radiation source (0.01 to 100 mW/cm²) for an optimised time (depending upon the support and application). In general this time varies between approximately 1 min to 60 min. The monolith is then washed with an inert organic solvent for a time corresponding to around 100 column volumes. Suitable inert organic solvents for washing the monoliths are an alkane for example or a mixture of C₅ to C₈ alkanes, toluene, tetrahydrofurane, ethyl acetate.

Also, it is possible to conduct photoinitiation of polymerization without the use of a photoinitiator added to the base composition: this is a specific characteristic of mixtures of maleic anhydride and electron-donor monomers such as vinyl ethers; the formation of a charge transfer complex absorbing in the near UV appears to be the cause of this behaviour. These formulations can be polymerized under UV following the same procedure as described above, but without the addition of a photoinitiator. Polymerization time ranges from about 20 min to 2 h 30. The monolith is then washed in an inert organic solvent for a time corresponding to approximately 100 column volumes.

In another variant of embodiment, the method to prepare monolithic materials comprises a polymerization reaction under ionizing radiation of the base composition, in particular under a beam of electrons (radiochemical initiation). The containing objects filled with precursors are irradiated without initiator, with doses varying between 10 and 1000 kGy and at varied dose rates: from 0.01 to 100 kGy/s. The monolith is then washed with an inert organic solvent for a time corresponding to approximately 100 column volumes.

The prior surface treatment of the walls of the site where it is desired to form the monolith is an essential element to obtain satisfactory anchoring of the monoliths, and it is performed by grafting these surfaces with nucleophilic compounds. Also, the presence of maleic anhydride functions in the monoliths provides for particularly efficient grafting of the surfaces with nucleophiles, such as the amine functions of gamma-aminopropyltrimethoxysilane (gamma-APS) fixed to the surface of substrates in glass or silica, or the amine functions introduced onto the surface of substrates in polymer materials, in particular those used in analytical Microsystems e.g. the lithography-compatible SU-8 resin, after treatment with ammonia or an organic amino compound.

A study of the parameters influencing polymerization of monoliths containing maleic anhydride was conducted, whose results are given below.

### Effect of Polymerization Time and Dose

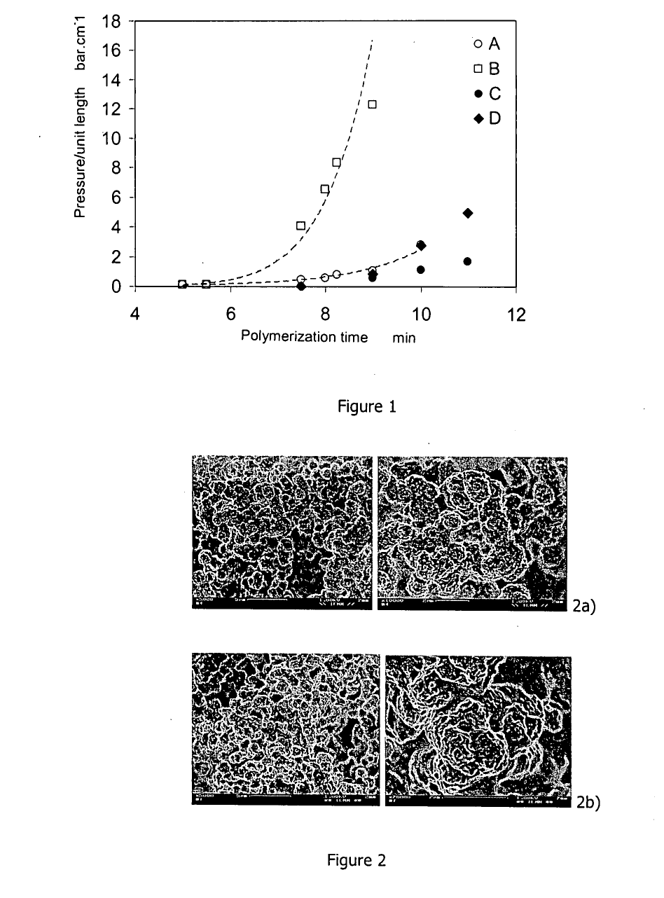

The effect of an increase in polymerization time on the permeability of monoliths is shown in appended FIG. 1. The graph shows the influence of polymerization time on friction loss induced by the presence of a maleic anhydride monolith polymerized under UV radiation in a capillary, before (points A) and after (points B) modification of the maleic anhydride units with n-hexylamine. Similarly, polymerization of monolith precursor mixtures containing maleic anhydride was performed under electron beams with doses of 10 kGy to 500 kGy and varied dose rates: from 0.01 kGy/s to 100 kGy/s; the formation of monoliths was observed with an increase in induced friction loss in relation to the dose applied.

### Effect of Monomer Percentage on Polymerization

Polymerizations were performed in columns of variable diameters from 50 μm to 1 mm, with phases containing 10% to 40% monomers.

### Effect of a Decrease in Column Diameter on Polymerization

Polymerizations were performed in columns with diameters varying from 50 μm to 1 mm. Morphology studies do not show any spectacular effect of reduced diameters on the morphology of our monoliths. Appended FIG. 2 shows pictures taken by scanning electronic microscope illustrating the morphology of maleic anhydride monoliths in capillaries of different diameters (upper inner diameter 1 mm, lower, inner diameter 75 mm, polymerized under UV radiation) before modification (FIG. 2a, diameter 1 mm) and after modification (FIG. 2b, diameter 75 μm).

According to a third aspect, the inventions relates to compositions containing maleic anhydride, comonomers and/or other monomers and porogenic solvents used to prepare monolithic materials according to the invention.

Generally, the method to prepare monolithic materials uses a base composition containing:
maleic anhydride as basic monomer, associated with electron-donor ethylene comonomers and/or other electron-donor or electron-acceptor ethylene monomers;
a mixture of porogenic solvents, a thermal initiator or photoinitiator possibly being added or not being added to said base composition.

In certain embodiments of the invention, the method to prepare monolithic materials uses a composition A which, in addition to the base composition, contains a thermal initiator. In this case, the molar content of maleic anhydride, assessed in relation to the number of moles of polymerizable functions in the mixture of monomers, lies between 0.1 and 0.5, preferably between 0.2 and 0.5, whereas the monomer:porogenic solvent ratio lies between 10-90 wt. % and 40-60 wt. %; the thermal initiator is present to a proportion of between 0.05 to 5 wt. %.

In other embodiments of the invention, the method to prepare monolithic materials uses a composition B containing a photoinitiator in addition to the base composition. In this case, the molar content of maleic anhydride, assessed with respect to the number of moles of polymerizable functions in the mixture of monomers, lies between 0.1 and 0.5, preferably between 0.2 and 0.5, whereas the monomer:porogenic solvent ratio lies between 10:90 wt. % and 40:60 wt. %, and the photoinitiator is present in a concentration of between 0.2 and 5 wt. %.

Preferably, the comonomers included in these compositions are chosen from the group: styrene and mono or multi-functional styrene derivatives, mono- or multifunctional vinyl ethers (cyclohexyl vinyl ether, 1,4-cyclohexane dimethanol divinyl ether), N-vinyl derivatives (N-vinyl pyrrolidone, N-vinyl carbazole), mono- or multifunctional acrylic and methacrylic esters (butyl acrylate, methyl methacrylate, hexanediol diacrylate, tripropyleneglycol diacrylate), mono- or multifunctional acrylic and methacrylic amides, mono- and multifunctional N-alkyl or N-aryl maleimides.

The mixture of porogenic solvents included in the compositions of the invention comprises at least two solvents preferably chosen from the group: pentane, hexane, cyclohexane, petroleum ether, toluene, dioxane, tetrahydrofurane, dichloromethane, ethyl acetate, alcohols.

Preferably, the thermal initiator is chosen from the group: azobis-isobutyronitrile, 2,2-azobis(2-amidinopropane dihydrochloride, 2,2-azobis(isobutyramide) dihydrate, benzoyl peroxide, dipropylperoxodicarbonate.

The limited solubility of maleic anhydride in some solvents and the reactivity of its anhydride function in some solvents or in the presence of other monomers, requires the determination of the compositions which are suitable for the proper implementation of the method. Through a judicious choice of reagents, and under varied initiating conditions (thermal, photochemical or radiochemical ([electron beam]) it is possible to obtain monoliths having the desired permeability. Amongst the various compositions which were systematically assessed, it was possible to choose several monolith precursor formulations having porosity characteristics (i.e. friction loss at a given flow rate) within the desired range of values.

One of the basic formulations to form a maleic anhydride gel with a vinyl ether contains maleic anhydride (MA) associated with triethylene-glycol divinyl ether (DVE3) or with 1,4-cyclohexane dimethanol divinyl ether (CHVE) with a molar ratio of maleic to vinyl unsaturations of 1:1 in a mixture of solvents: ethyl acetate:cyclohexane (50-50 wt. %).

The use of two molecules of maleic anhydride for one of these diether types ensures a higher number of anhydride functions than in other known functionalizable monolithic materials. Copolymerization is alternate and spaces the functionalizable groups apart.

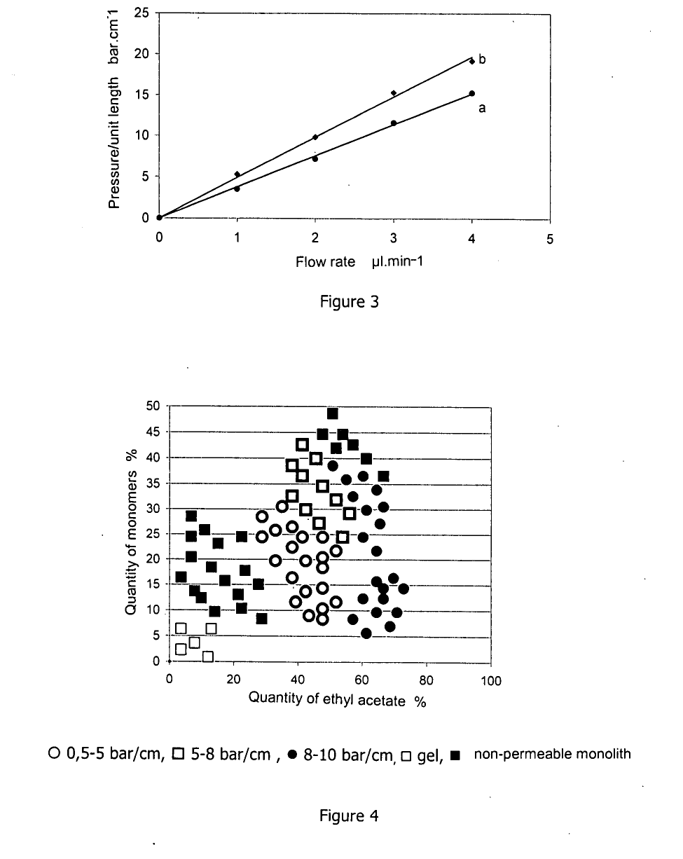

The fluidic behaviour of these monoliths was studied in capillaries or channels of Microsystems with an inner diameter of 75 μm and tetrahydrofurane (THF) flow rate varying between 1 μl/min and 4 μl/min. Pressure measurements given in appended FIG. 3 show that the increase in friction loss with flow rate occurs linear fashion in a column consisting of a monolith containing maleic anhydride and triethyleneglycol divinyl ether polymerized in a capillary with an inner diameter 75 μm, by exposure to UV radiation for 2 min (FIG. 3a) and for 3 min (FIG. 3b). These phases are easily polymerizable under UV radiation with and without the use of a photoinitiator.

For each ratio of monomers to solvents (weight percentages): 40%-60%; 25-75%; 20%-80%; 10%-90%, various formulations of porogenic solvents were studied. The permeability of the maleic anhydride monoliths can be adjusted by variations in the composition of the formulations, in terms of the proportion of monomers in the precursor mixture, and of the composition of the porogenic solvent mixture. Appended FIG. 4 shows the influence of composition, in terms of weight content of monomers (maleic anhydride and vinyl diether, with equimolar unsaturated functions) and of ethyl acetate in the monolith precursor mixture, on friction loss per unit length for a flow rate of 1 μl/min after polymerization under UV radiation (3 min, inner diameter of capillary 75 μm).

Other examined formulations comprise maleic anhydride and hexanediol diacrylate as monomers, the molar ratio between the molecules of monomers being 2:1 whereas the weight ratio is 1:1.15. With these formulations it is possible to obtain another type of phase with a high maleic anhydride content, suitable permeability and homogeneous morphology.

The following formulations were developed to obtain phases with greater permeability than in the preceding samples, by adding a mono-acrylate of butyl acrylate type or a diacrylate associated with a vinyl ether:
MA:TPGDA, the molar ratio between the monomer molecules being 2:1, and the weight ratio being 1:1.53,
MA:BMA:DVE3, the molar ratio between the monomer molecules being 1:1:1, and the weight ratio being 1:1.45:1.7,
MA:BMA:CHVE, the molar ratio between the monomer molecules being 1:1:1, and the weight ratio being 1:1.45:1.7,
MA:DVE3:HDDA, the molar ratio between the monomer molecules being 4:1:1, and the weight ratio being 2:1:1.13,
MA:DVE3:TPGDA, the molar ratio between the monomer molecules being 4:1:1, and the weight ratio being 2:1:1.5,
MA:CHVE:HDDA, the molar ratio between the monomer molecules being 4:1:1, and the weight ratio being 2.3:1:1.3,
MA:BMA:HDDA, the molar ratio between the monomer molecules being 1:1:1, and the weight ratio being 1:1.45:2.3,
MA:BMA:TPGDA, the molar ratio between the monomer molecules being 1:1:1, and the weight ratio being 1:1.45:3,
MA:BMA:DVE3:HDDA, the molar ratio between the monomer molecules being 2:2:1:1, and the weight ratio being 1:1.45:1:1.15,
MA:BMA:DVE3:TPGDA, the molar ratio between the monomer molecules being 2:2:1:1, and the weight ratio being 1:1.45:1:1.5,
MA:BMA:CHVE:HDDA, the molar ratio between the monomer molecules being 2:2:1:1, and the weight ratio being 1.17:1.7:1:1.3,
MA:BMA:CHVE:TPGDA, the molar ratio between the monomer molecules being 2:2:1:1, and the weight ratio being 1.17:1.7:1:1.8.

The abbreviations used are: MA for maleic anhydride, BMA for butyl methacrylate, CHVE for 1,4-cyclohexane dimethanol divinyl ether, DVE3 for triethylene glycol divinyl ether, HDDA for 1,6-hexanediol diacrylate, TPGDA for tripropylene glycol diacrylate.

Judicious combination of the composition of the precursor mixtures and conditions of polymerization allows monolithic materials to be obtained having a well-defined permeability.

Therefore columns prepared for chromatography under these conditions, through which THF is passed at a rate of 1 mL/min, lead to a friction loss of between 3 bars and 150 bars for a length of 20 cm and an inner diameter of 75 μm.

According to a fourth aspect, the invention concerns monolithic materials in which the maleic anhydride functions are functionalized by reaction with nucleophilic compounds.

Functionalization is performed by adding nucleophiles by infusion or in the form of an aqueous, organic, hydro-organic solution, or an emulsion or mini- or microemulsion. The chemical nature of these compounds may be most varied: simple organic compounds carrying at least one nucleophilic function (such as aliphatic or aromatic amines, alcohols, phenols, phosphines, and compounds with activated hydrogen), compounds with more complex hydrocarbon backbone and/or carrying multiple neutral or ionic chemical functions, oligomers and synthetic polymers, proteins, enzymes, antibodies, nucleic acids etc.

The properties resulting from this functionalization are consequently extremely varied: adjustable hydrophilic/hydrophobic balance, presence of positive or negative electric charges, of functional organic groups possibly optically active, of specific substrates, of recognition sites, of artificial or enzymatic catalytic sites.

The monoliths containing the maleic anhydride functions also have the advantage of possessing ionic functions of carboxylate type, generated either by coupling with the functional nucleophile, or by hydrolysis of the entirety or residue of maleic anhydride functions. These ionized functions may prove to be highly useful to perform capillary electro-chromatography or to generate an electro-osmotic flow for the transport of solvents or solutions in the microsystems.

The conditions for chemical modification of the different monoliths containing maleic anhydride functions were examined: effect of concentration, of the type of solvent (aqueous or not), of pH. In particular, it is possible to achieve the coupling of nucleophiles in an aqueous solution with great efficacy under certain pH conditions.

Persons skilled in the art can contemplate the simultaneous coupling of different nucleophiles: for example an active biological compound and polyethylene glycol carrying an amine function (peg-NH₂) to adjust the hydrophilic nature of the functionalized porous material. Subsequent hydrolysis enables de-activation of any maleic anhydride functions which may not have reacted.

Functionalization with Aliphatic Amines with 4 to 18 Carbon Atoms

Functionalization is performed dynamically, under gentle conditions, by infusing a variable concentration (0.5 wt. % to 50 wt. %) of a solution of the amine in THF, toluene or acetonitrile (depending on the type of amine) through the column for a time of between 1 h and 4 h. Once the modification is completed, the column is washed with THF, then the residual maleic anhydride functions are neutralized for approximately 1 h by infusing a buffer solution of tris (hydroxymethyl)aminomethane (TRIS) pH 8.

Functionalization with Enzymes: Trypsin

Modification with trypsin is performed dynamically for a time varying between in to 4 h according to chosen temperature, most often between 4° C. and 25° C. The range of concentrations chosen for immobilisation of the trypsin was determined between 0.02 mg/ml up to 1 mg/ml trypsin in a phosphate buffer depending on the volume of the reactor. The reactor is then washed with a phosphate buffer solution (PBS) and then with TRIS buffer to pack the column.

Functionalization with a Peptide: Streptavidin

The immobilization protocol is similar to the one described in the example of trypsin immobilization; the concentration of streptavidin is 0.01 mg/ml with an immobilization time of 1 to 8 h at ambient temperature.

Functionalization with Synthetic Polymers: with Terminal Primary Amine Function

Modification is performed by infusing the monolith with a solution of a polymer, in THF, having a primary amine end (poly(N-isopropylacrylamide) or polyethylene glycol) and a tertiary amine such as triethylenediamine for 1 h to 4 h, depending on the concentration of the functional polymer to be grafted, depending on its extent of polymerization and depending on the concentration of tertiary amine.

The functionalized maleic anhydride monolithic materials of the invention were characterized by several methods, as described in the following examples.

### Characterization by Infrared Spectroscopy

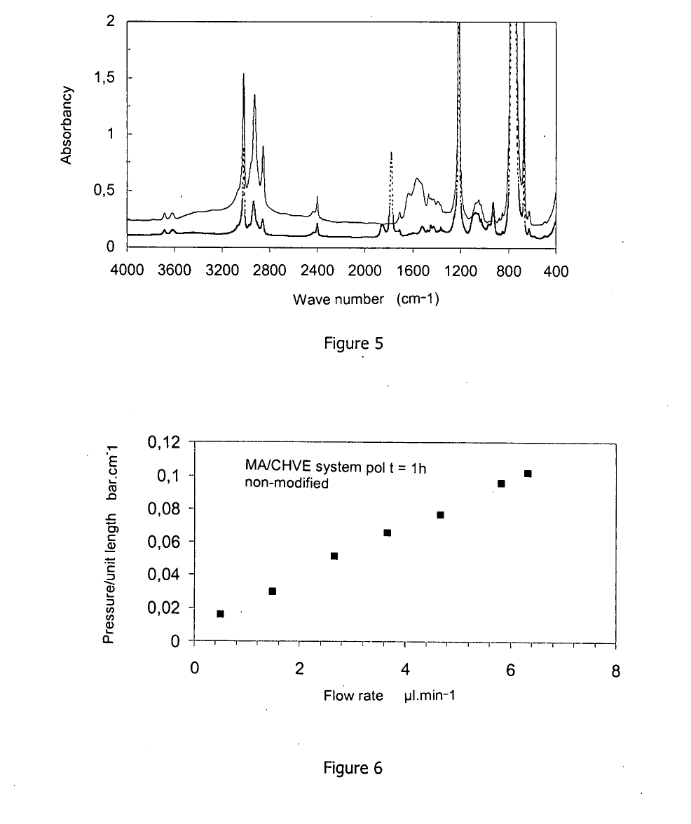

Monoliths functionalized with aliphatic amines and polymers were characterized by infrared spectroscopy (IR) after washing and drying. The analyses were performed in transmission mode after preparing a pellet of monolith powder, before and after modification with KBr. In the spectrum of the modified monolith, the onset of amide bands was observed at 1654 cm⁻¹ and 1556 cm⁻¹, and disappearance of bands characteristic of the anhydride function at 1855 cm⁻¹ and 1780 cm⁻¹. One example is shown in appended FIG. 5, which illustrates the changes in the IR spectrum of powders prepared from maleic anhydride monoliths, before and after modification with n-dodecylamine.

### Characterization by Fluorescence

Monoliths modified with receptors of specific interactions were characterized by fluorescence, at 532 nm, of the marker carried by streptavidin-Cy3 excited at 580 nm. Distinct fluorescence was observed of the samples modified with streptavidin, and no fluorescence on reference monoliths.

### Characterization by Elemental Analysis of Nitrogen

Monoliths modified with various molecules (such as trypsin) were characterized by elemental analysis of nitrogen.

### Measurement of Friction Loss

Structural modifications induced by chemical functionalization are accompanied by limited modifications to the permeability of monoliths. Clogging of the porous structure is avoided. Pressure measurements at different solvent flow rates showed limited increases in friction loss.

The results shown FIG. 1 illustrate the modified changes obtained after treatment with n-hexylamine.

### Hydrolysis of BAEE on Trypsic Reactors

The enzymatic activity of the monolithic phases functionalized with trypsin was measured by studying the hydrolysis kinetics of N-benzoyl arginine ethyl ester (BAEE). Trypsic reactors prepared following different protocols were supplied with a substrate solution by means of a syringe driver and connected downstream to a circulation cell placed in a UV spectrometer. The efficacy of hydrolysis was continuously monitored by measuring absorbency at 253 nm.

The fluidic properties of the maleic anhydride monolithic materials of the invention were characterized using the different methods described below.

### Fluidic Characterization at Low Pressure

Monoliths having high permeability, prepared from some maleic anhydride formulations by thermal, photochemical or radiochemical polymerization, were the subject of flow rate measurements under low pressure (THF, toluene at constant pressure less than 0.05 bar). Appended FIG. 6 shows the flow properties of toluene through a phase consisting of MA/BMA/CHVE monomers, polymerised under UV radiation for 1 h in a column of 1 mm and non-modified (low friction loss, 3 bars on a column of 20 cm in length and 75 μm inner diameter).

Fluidic Characterization at High Pressure

Maleic anhydride monoliths of lesser permeability, prepared from some maleic anhydride formulations by thermal, photochemical or radiochemical polymerization in capillaries of inner diameter ranging from 75 μm to 1 mm, were subjected to friction loss measurements. The flow of a solvent is ensured by a HPLC pump (Water) at a rate varying from 1 μl/min to a few dozen μl/min, or by a high pressure syringe driver (Harvard Instrumentation). Pressures reaching as high as 150 bars were measured for THF flowing at a rate of 1 μl/min in a capillary of length 20 cm and inner diameter 75 μm.

### Fluidic Characterization of Microsystems

The fluidic characterization of microsystems containing maleic anhydride monoliths prepared inside channels of SU-8 photolithographied resin, capped with pyrex, was conducted at THF flow rates of between 1 μl/min and 10 μl/min. The curves denoted C and D shown by the graph in appended FIG. 1 show the effect of polymerization time on the fluidic properties of a microsystem with channel width of 100 μm and height 150 μm, containing a maleic anhydride monolith over a length of 4 cm, before (points C) and after (points D) functionalization with n-hexylamine.

### Morphological Characterization of Monoliths

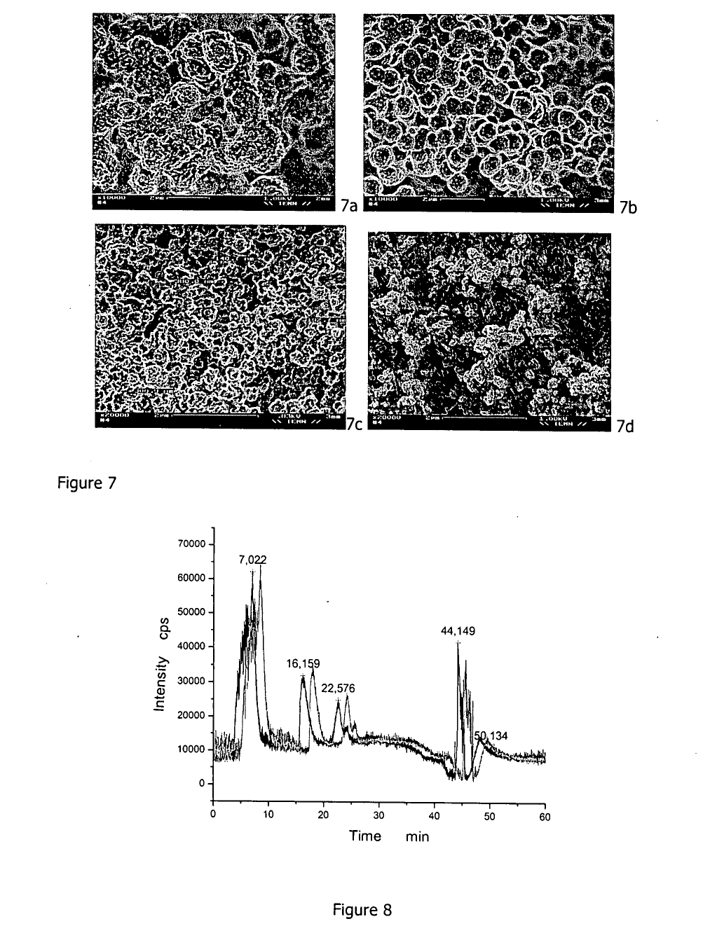

Maleic anhydride monoliths prepared according to the invention were characterized by scanning electronic microscopy. Appended FIG. 7 shows four monolithic phases with high maleic anhydride content: FIG. 7a: Mixture of MA/CHVE/BMA monomers of which 28% of the polymerizable functions derive from the maleic anhydride, the porogen containing ethyl acetate; FIG. 7b: Mixture of MA/CHVE/BMA monomers of which 28% of polymerizable functions derive from the maleic anhydride, the porogen containing toluene; FIG. 7c: Mixture of MA/CHVE monomers, of which 50% of polymerizable functions derive from the maleic anhydride, the porogen containing ethyl acetate; FIG. 7d: Mixture of MA/DVE3 monomers, 50% of the polymerizable functions deriving from the maleic anhydride, the porogen containing ethyl acetate. Analysis of macroporosity and of particle size was performed using SCION Image analysis software.

According to a fifth aspect, the invention relates to various uses of functionalized monolithic materials for analytical microsystems. Preferably the functionalized monolithic materials of the invention are used:
as phase for the separation of molecules using a chromatographic technique chosen from the group: affinity, hydrophobic interaction, ionic, electrochromatography, capillary electrophoresis;
as reactor, support for reagent or catalyst for chemical or enzymatic reaction,
as support for absorption, analysis and detection of chemical compounds;

The invention will be better understood on reading the following examples of embodiment which do no limit the invention.

### EXAMPLE 1

### Separation Reactor Obtained by Functionalization with n-hexylamine

Analyses of nano-liquid chromatography type (nano-LC) were conducted to assess the chromatographic performance of columns obtained from maleic anhydride monoliths prepared in capillaries and functionalized by reaction with alkylamines. Separation tests of the peptides contained in digestates of Cytochrome C and β-galactosidase were performed by injecting 0.1 μl to 1 μl of digestate solution, in a concentration ranging from 80 fmol/μl to 800 fmol/μl, into columns of inner diameter 75 μm and length of between 5 and 20 cm, eluting with water:acetonitrile linear gradient.

A glass capillary of length 20 cm, coated with polyimide, and inner diameter of 75 μm, whose inner surface was modified with a silane such as gamma-aminopropyltrimethoxysilane (gamma-APS), was filled with a solution containing 20 weight % monomers and the porogen consisting of toluene and cyclohexane. This column was then polymerized under an electron beam at a dose of 100 Gky and a rate of 0.68 kGy/s with passes of 25 kGy. After polymerization, the column was washed with THF for 1 h at 1 μl/min, then modified by a C6 amine in THF (10 wt. %) for 2 h, washed by infusing THF for 1 h and TRIS buffer for 1 h. Before separation, the column was stabilized by an infusion of a water:acetonitrile mixture (50-50 wt. %). The pressure throughout analysis did not exceed 49 bars for a column length of 20 cm.

The feasibility of separating the main peptides was demonstrated on columns 5 cm in length containing a monolith functionalized by n-hexylamine. The tracing obtained by mass spectrometer coupled with liquid nanochromatography during separation of Cytochrome C digestate (80 fmol/μl) on a column of length 8 cm and inner diameter 75 μm is given in appended FIG. 8. The most hydrophobic peptides of Cytochrome C were separated and showed a retention time of more than 15 min.

### EXAMPLE 2

### Trypsic Digestion Reactor

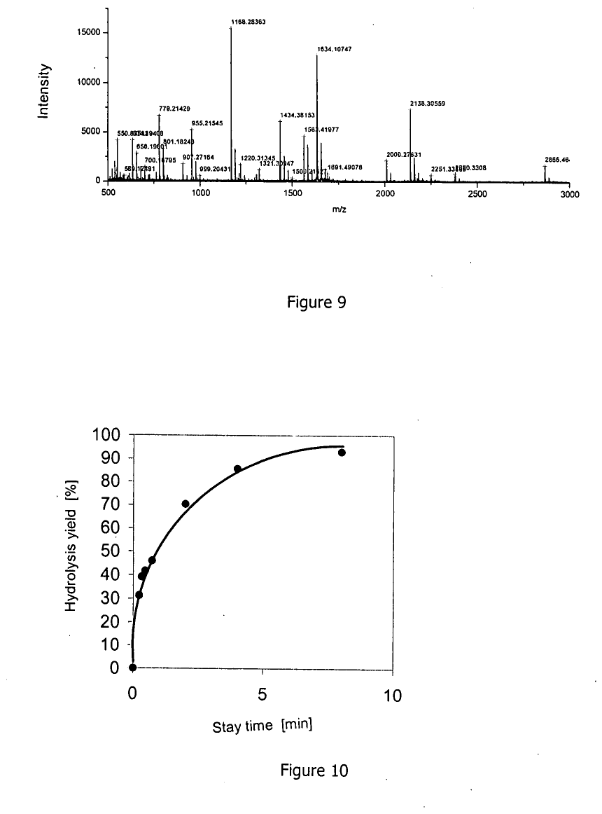

Trypsic digestion was performed on a column of length 8 cm and inner diameter 75 μm. The monolith was polymerized under UV radiation for 10 min, then washed for 1 h and modified with tryspin in 0.01 mg/ml PBS phosphate buffer for 1 h at 4° C. The column was then washed with PBS buffer then with TRIS buffer. Digestion of 20 pmol Cytochrome C was conducted continuously at a flow rate of 3.5 μl/min on a capillary 8 cm in length and 75 μm in diameter containing a maleic anhydride monolith functionalized with trypsin. The MALDI TOF mass spectrum obtained from 50 μl of digestate solution is given in appended FIG. 9. Examination of the data allows identification of the protein with 65% sequence overlapping.

### EXAMPLE 3

### Digestion Reactor

Hydrolysis of N-benzoyl arginine ethyl ester (BAEE) was performed on a column 10 cm in length and inner diameter 1 mm. The monolith was UV polymerized for 1 h, then washed with THF and modified with trypsin in PBS buffer at 0.01 mg/ml, by infusion for 4 h at 4° C. The column was then washed with PBS buffer then with TRIS buffer. Hydrolysis of BAEE (0.25 mM) was conducted by dynamic infusion with UV spectrometry detection at 253 nm. Hydrolysis of BAEE gives a yield close to 91%, when the stay time in the column is correctly chosen, as shown by the graph in appended FIG. 10 (capillary of length 10 cm and diameter of 1 mm containing a maleic anhydride monolith functionalized by trypsin).

### EXAMPLE 4

### Affinity Reactor

Streptavidin was immobilized on maleic anhydride monolith phases prepared by polymerization under UV radiation. A specific interaction was conducted with a biotin-labelled fluorophore. Coupling efficacy was shown by fluorescence imaging of the biotinylated marker Cy5.

### EXAMPLE 5

### Thermal Valve

Porous phases were prepared in fluid Microsystems comprising channels passing through chambers of same section and of length 100 μm filled with monolith functionalized by poly(NIPAM) with terminal amine function. The temperature of the chambers can be modified using heating resistances inserted in the structure of the microsystem. The efficacy of functionalization and response stimulated by a controlled rise in temperature was shown by water flow tests in the channel at variable temperature; when applying a pressure of 1 bar the measured flow rate was 6 μl/min at 20° C. and increased to a value of between 20 and 40 μl/min at 40° C. according to the conditions of the conducted modification.

1. Polymer monolithic material with functionalizable groups, characterized in that these groups are maleic anhydride units.

2. Monolithic material according to claim 1, characterized in that it comprises alternating copolymers formed by radical reaction between the maleic anhydride as base monomer and electron-donor ethylene comonomers.

3. Monolithic materials according to either of claims 1 and 2, wherein the maleic anhydride functions are present in one out of every ten polymerizable functions, up to one out of every two polymerisable functions.

4. Method to prepare monolithic materials according to claim 1, characterized in that it consists of a radical polymerization reaction of a composition comprising a base composition containing:
maleic anhydride as base monomer, associated with electron-donor ethylene comonomers and/or with other electron-donor or electron-acceptor ethylene monomers;
a mixture of porogenic solvents,
a thermal initiator or a photoinitiator optionally being added to said base composition.

5. Method according to claim 4, characterized in that it comprises thermal polymerization reaction of a composition A comprising the base composition to which a thermal initiator is added, said reaction being conducted at a temperature of 40 to 90° C. for 1 to 6 h.

6. Method according to claim 4, characterized in that it comprises a photochemical polymerization reaction of the previously degassed base composition, said reaction comprising the following steps:
i. filling containing objects with the homogenized and degassed base composition;
ii. placing the filled tubes under a UV lamp of intensity 0.01 to 100 mW/cm² for a time of about 20 min to 2h30 until a monolithic material is obtained.

7. Method according to claim 4, characterized in that it comprises photochemical polymerization reaction of a composition B containing the base composition to which a photoinitiator has been added, said reaction comprising the following steps:
i. filling containing objects with the degassed and homogenized composition B;
ii. placing the containing objects under a UV lamp of intensity 0.01 to 100 mW/cm² for a time of about 1 min to 60 min until a monolithic material is obtained.

8. Method according to claim 4, characterized in that it comprises radiochemical polymerization reaction of the base composition, said reaction comprising the following steps:
i. filling containing objects with the degassed, homogenized base composition;
ii. irradiating the filled containing objects with doses of between 10 to 1000 kGy at a dose rate of between 0.01 and approximately 100 kGy/s until a monolithic material is obtained.

9. Method according to claim 5, characterized in that it comprises an additional step iii. to wash the monolithic material obtained at step ii. with an inert organic solvent for a time corresponding to approximately 100 column volumes.

10. Method according to claim 5, characterized in that said method comprises a prior step for the surface treatment of the walls acting as support for said monolithic materials, by grafting with nucleophilic compounds.

11. Method according to any of claim 6, characterized in that the containing objects comprise systems and devices of various geometries, consisting of glass, silica, silicon, polymer materials (thermoplastics, networks, lithographiable resins) or consisting of a combination of these various types of materials, comprising channels or chambers with a diameter of between 100 nm and 5 cm.

12. Base composition used in the method to prepare monolithic materials according to claim 4, characterized in that it comprises:
maleic anhydride as base monomer, associated with electron-donor ethylene comonomers and/or other electron-donor or electron-acceptor ethylene monomers;
a mixture of porogenic solvents,
and in that:
the molar maleic anhydride fraction, assessed with respect to the number of moles of polymerizable functions in the mixture of monomers, lies between 0.1 and 0.5, preferably between 0.2 and 0.5;
the ratio of monomers:porogenic solvents lies between 10-90 wt. % and 25:75 wt.

13. Composition A used in the method according to claim 5, characterized in that it contains a base composition comprising:
maleic anhydride as base monomer, associated with electron-donor ethylene comonomers and/or other electron-donor or electron-acceptor ethylene monomers:
a mixture of porogenic solvents,
wherein:
the molar maleic anhydride fraction, assessed with respect to the number of moles of polymerizable functions in the mixture of monomers, lies between 0.1 and 0.5, preferably between 0.2 and 0.5; and
the ratio of monomers:porogenic solvents lies between 10-90 wt. % and 25:75 wt. %,
to which base composition a thermal initiator is added, wherein the thermal initiator is present in a concentration ranging from 0.05 to 5 wt. %.

14. Composition B used in the method to prepare monolithic materials according to claim 7, characterized in that it contains a base composition comprising:
maleic anhydride as base monomer, associated with electron-donor ethylene comonomers and/or other electron-donor or electron-acceptor ethylene monomers:
a mixture of porogenic solvents,
wherein:
the molar maleic anhydride fraction, assessed with respect to the number of moles of polymerizable functions in the mixture of monomers, lies between 0.1 and 0.5, preferably between 0.2 and 0.5:and
the ratio of monomers:porogenic solvents lies between 10-90 wt. % and 25:75 wt. %,
to which base composition a photoinitiator is added, wherein the photoinitiator is present in a concentration ranging from 0.2 to 5 wt. %.

15. Composition according to claim 12,
characterized in that the comonomers are chosen from the group: styrene and mono- or multifunctional styrene derivatives, mono- or multifunctional vinyl ethers, N-vinyl derivatives, mono- or multifunctional acrylic and methacrylic esters, mono- or multifunctional acrylic and methacrylic amides, mono- and multifunctional N-alkyl or N-aryl maleimides.

16. Composition according to claim 12, characterized in that the mixture of porogenic solvents comprises at least two solvents chosen from the group: pentane, hexane, cyclohexane, petroleum ether, toluene, dioxane, tetrahydrofurane, dichloromethane, ethyl acetate, alcohols.

17. Composition according to claim 12, characterized in that it contains maleic anhydride and triethyleneglycol divinyl ether at a molar ratio of maleic and vinyl unsaturations of 1:1 in a 50-50 wt. % ethyl acetate:cyclohexane solvent mixture.

18. Composition according to claim 12, characterized in that it contains maleic anhydride and 1,4-cyclohexane dimethanol divinyl ether with a molar ratio of maleic and vinyl unsaturations of 1:1 in a 50-50 wt. % ethyl acetate:cyclohexane solvent mixture.

19. Monolithic material according to claim 1, characterized in that the maleic anhydride functions are functionalized by reaction with nucleophilic compounds.

20. Monolithic material according to claim 19, characterized in that the nucleophilic compounds are added by infusion or in the form of an aqueous, organic, hydro-organic solution, emulsion, mini or microemulsion.

21. Monolithic material according to claim 19, characterized in that the nucleophilic compounds are chosen from the group: simple organic compounds carrying at least one nucleophilic function (such as aliphatic or aromatic amines, alcohols, phenol phosphines and compounds with activated hydrogen, compounds with more complex hydrocarbon backbone and/or carrying multiple neutral or ionic chemical functions, oligomers and synthetic polymers, proteins, enzymes, antibodies, nucleic acids.

22. Use of monolithic materials according to claim 19 as phase for the separation of molecules by a chromatographic method chosen from the group:
by affinity, hydrophobic interaction, ionic, electrochromatographic, capillary electrophoresis.

23. Use of the monolithic materials according to claim 19 as reactor, support for reagent or catalyst for chemical or enzymatic reaction.

24. Use of the monolithic materials according to claim 19 as support for absorption, analysis and detection of chemical compounds.
